(19) United States
(12) Patent Application Publication
(10) Pub. No.: US 2003/0089554 A1
(43) Pub. Date: May 15, 2003

(54) Method of applying lubricant to nut threads and resulting product

(75) Inventor: Wolf Alan Ralph, Painesville Township, OH (US)

Correspondence Address: DRIGGS, LUCAS, BRUBAKER & HOGG CO., L.P.A., DEPT. DLBH, 8522 EAST AVENUE, MENTOR, OH, 44060, US

(73) Assignee: The Dyson Corporation, Painesville Township, OH

(21) Appl. No.: 10/045,374

(22) Filed: Nov. 9, 2001

(51) Int. Cl. F16N 7/12

(52) U.S. Cl. 184/19

(57) ABSTRACT

A method of and device for applying a liquid coating to the threads and only the bearing face of a threaded nut and the resulting coated nut are provided. The method includes providing a pumping mechanism that has a container containing the liquid lubricant and a pumping mechanism connected with the container. The pumping mechanism includes a liquid ejecting device having an actuatable delivery mechanism. A foraminous pad supports the face of a nut that is to have liquid lubricant applied thereto. A nut to be coated with the lubricant is placed on the foraminous pad and thereafter the delivery mechanism is actuated to eject liquid onto the threads and the foraminous pad to provide a nut which has coating on only the threads and on the bearing surface or face.

### BACKGROUND OF THE INVENTION

1. Field of the Invention

This invention relates generally to applying a lubricant to nut threads and the resulting product and, more particularly, to a method of applying a wax and dye coating only to the threads of a nut and to one face thereof while maintaining the remainder of the nut free of the wax and dye.

2. Background Information

In certain applications of threaded nuts, particularly in their use in connecting various bridge elements together, nuts are threaded onto bolts to hold the elements of the bridge in place. These are typically very large bolts and nuts and it is required that they be torqued down to a rather high torque to assure reliable connections. Because of their relatively large size and frictional resistance, it is somewhat difficult to achieve the high torque necessary to assure this reliable connection. Therefore, it is desirable to provide some kind of lubricant, particularly to the threads, and also preferably to the bearing face of the nut, to allow or permit the torquing to be done more easily. However, conventional lubricants, such as wax or wax and dye which are conventionally specified as lubricants, are repellant to paint and, thus, the exposed surfaces of the nut, i.e. the torquing surfaces and the free surface of the nut, must be maintained clear of the lubricant if the bridge structure is to be painted. It is thus desirable to provide a technique for supplying a selectively coated nut, as well as a process and device for coating the threads and the bearing surface or face of the nut with a lubricant, such as a wax and dye, while maintaining the other surfaces free of such lubricant.

### SUMMARY OF THE INVENTION

According to the present invention, a method of and device for applying a liquid coating to the threads and only the bearing face of a threaded nut and the resulting coated nut are provided. The method includes providing a pumping mechanism that has a container to receive the liquid lubricant to be applied and a pumping mechanism connected with the container. The pumping mechanism includes a liquid ejecting device connected with the container, including an actuatable delivery mechanism communicating with the container. A foraminous pad is disposed to support the face of a nut that is to have liquid lubricant applied thereto. The delivery mechanism, upon actuation, will dispense the liquid only on the threads of the nut on the foraminous pad. A nut to be coated with the lubricant is placed on the foraminous pad and thereafter the delivery mechanism is actuated to eject the liquid onto the threads and the foraminous pad to thereby provide a nut which has coating on only the threads and on the bearing surface or face that is to be engaged with a member being connected.

### DESCRIPTION OF THE DRAWINGS

FIG. 1 is a sectional view of a galvanized, threaded nut which has been coated with a lubricant, according to the present invention, on the threads and bearing surface only thereof;

FIG. 2 is a longitudinal, sectional view of a device for applying a coating to the threads and bearing surface of a nut in an unactuated condition; and

FIG. 3 is a view similar to FIG. 2 of the device in the actuated condition.

### DESCRIPTION OF THE PREFERRED EMBODIMENT

Referring now to the drawings, and for the present to FIG. 1, a threaded, galvanized nut N having been coated with a wax and dye lubricant W/D according to this invention is shown. The nut N includes internal threads T having a bearing face BF and a free face FF. The threads T and bearing face BF have had applied thereto a wax and dye W/D coating according to a method which will be described presently. The wax and dye coating W/D is a wax lubricant with a dye disposed therein. Preferably, this is Castrol Safety Film 639 manufactured by Castrol Industrial Great Lakes, Inc. It is to be understood that this particular wax and dye W/D is illustrative only, but it is preferred since this is the wax and dye that is specified for many applications of nuts in the bridge construction industry.

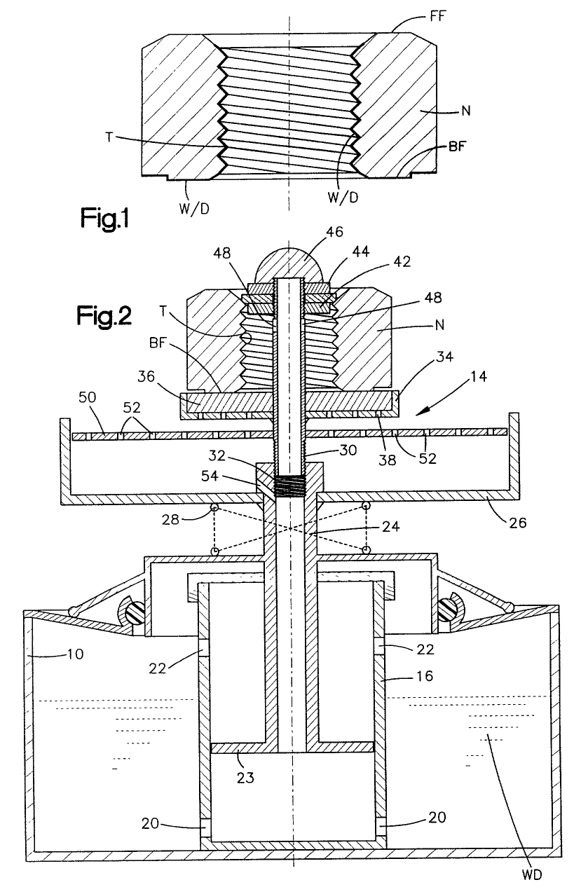

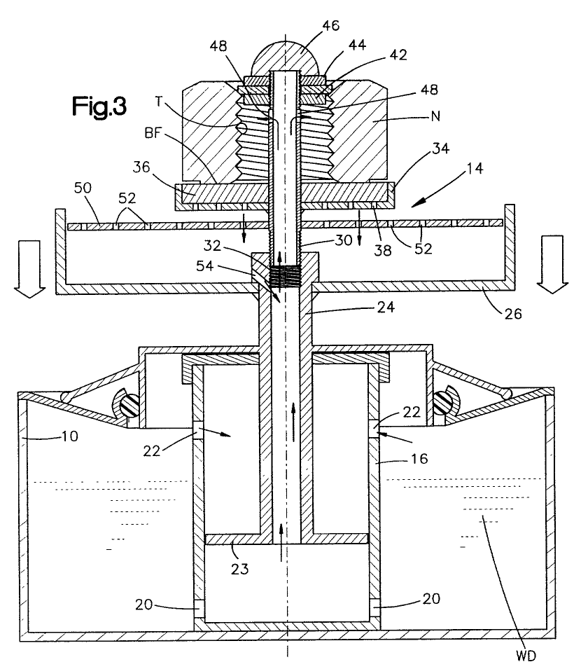

Referring now to FIGS. 2 and 3, a mechanism for coating only the threads T and the bearing face BF of the nut, while allowing the free face FF, as well as torquing or tightening faces TF of the nut N, to remain uncoated, is provided.

The coating mechanism includes a container 10 having the wax and dye W/D disposed therein. As indicated above, the wax and dye preferably is Castrol Safety Film 639 and, in condition to be sprayed when in the container 10, has a viscosity which approximates that of water at ambient temperature. The device includes a pumping mechanism designated generally as 14 which includes a hollow fill tube 16 which extends into the container 10 and is secured thereto by a collar 17 which is connected to the container 10 by means of a cam member 18, a roller 19 and pin 20 mounted on the collar 17 and engaging camming surface 21 on cam member 18, thus allowing the pumping mechanism 14 to be removed to fill the container 10 with wax and dye W/D. The hollow fill tube has fluid inlet openings 22 at the distal end and air escape openings 23 adjacent the collar 17.

A hollow ejection tube 24 is provided which extends through the collar 17 and terminates in a piston ring 25 in sealing relationship with the hollow fill tube 16 between the inlet openings 22 and air escape openings 23. A holding tray 26 is welded to the end of hollow fill tube 16 and a spring 28 is interposed between the holding tray 26 and the collar 17. A hollow extension tube 30 is provided which threadably engages internal threads 32 of the hollow ejection tube 24. A cup-shaped support member 34 is welded to the hollow extension tube 30 and a foraminous pad 36 is disposed in the support member 34. The foraminous pad 36 preferably is formed of a disc of Scotchbrite material manufactured and sold by 3M Corporation. However, other material, such as felt, may be used. Support member 34 has holes 38 therein which allow liquid to drain from the support member 34 into the holding tray 26.

The distal end of the hollow extension tube 30 is threaded as at 40 and a jamb nut 42 is threaded onto the threaded portion 40. An annular shield 44, which preferably is also made of Scotchbrite (or other material, such as felt could be used) and which has a diameter slightly larger than the internal diameter of the nut to be coated, is provided over the threaded end 40 of the hollow extension tube 30 abutting the jamb nut 42. A thumb nut 45 is threaded onto threads 40 and captures the shield 44 between it and thumb nut 42. A cap nut 46 is threaded on threads 40 to close the end of hollow extension tube 30. The hollow extension tube 30 is provided with a series of circumferentially spaced orifices 48 from which the wax and dye W/D is ejected upon actuation, as will be described presently.

A drain member 50 is provided which resides in the holding tray 26, the drain member 50 having drain holes 52 therein to allow the liquid which drains from the support member 34 to drain into the holding tray 26. A drain orifice 54 is provided in the hollow ejection tube 24 to allow the drained fluid in the holding tray 26 to drain back down through the hollow ejection tube 24 into the hollow fill tube 16 and thence into the container 10.

The operation of the device for coating a threaded nut is as follows: a nut N to be coated is placed over the hollow extension tube 30, which extension tube 30 extends through the central opening in the nut so that the bearing face BF of the nut is against the foraminous pad 36, and the annular shield 44 is disposed at the end of the threaded portion T of the nut, as shown in FIG. 2. A downward pressure is applied to the nut to actuate the coating device by moving it from the position shown in FIG. 2 to that shown in FIG. 3. As shown in FIG. 3, the pumping mechanism 14 will be actuated, which will move the hollow ejection tube 24 and hollow extension tube 30 and piston ring 25 downwardly in the hollow fill tube 16 against the bias of spring 28. The downward pressure will cause the liquid contained in the hollow fill tube 16 to be forced up through hollow ejection tube 24 and hollow extension tube 30 and be ejected through the orifices 48. Also, some liquid will be ejected through orifices 54 but this does not matter since enough liquid to coat the threads and soak the pad 36 will be ejected from orifices 48. It is also to be understood that there will be some pressure to eject the fluid from the inlet openings 22; however, since there is liquid wax W/D in the container, the action will be against a greater fluid head than at escape openings 22 and orifices 48 which are exposed only to air. Thus, there is minimal fluid flow through openings 20. The result is that sufficient liquid W/D is expelled through orifices 48 to coat the threads T and soak the pad 36 to coat the bearing face BF of the nut N. This ejection of the wax and dye W/D from the orifices 48 wll spray the wax and dye W/D onto the threads T of the nut N and also onto the foraminous pad 36. Also, excess wax and dye W/D from the threads T will also leak onto the pad 36. The sprayed wax and dye W/D from the orifices 48 will coat the threads T of the nut N, and the wax and dye W/D in the foraminous pad 36 will coat the bearing face BF of the nut N with the wax and dye W/D. However, the annular shield 44 will prevent the wax and dye W/D from spraying out through the end of the nut and confine the coating only to the threads T and to the foraminous pad 36. Thus, the free face FF and torque face TF of the nut N are maintained free of the wax and dye W/D.

When the pumping mechanism 14 has been completely actuated, as shown n FIG. 3, pressure on the nut is relieved, allowing the spring 28 to return the pumping mechanism 14 to the position shown in FIG. 2. Upon return to the position shown in FIG. 2, a vacuum will be created within the hollow extension tube 30 and the hollow ejection tube 24 and, thus, the air pressure on the surface of the wax and dye W/D in the container 10 will force the wax and dye W/D through opening 22 up into the tubes 24 and 30 to refill the tubes ready for the next actuation.

As the foraminous pad 36 becomes saturated, the excess wax and dye W/D in the foraminous pad 36 will drain through openings 38 and 52 into the holding tray 28 and thence through drain orifice 54 into the ejecting tube 24. The nut N is then removed, and the shield 44 will wipe away any excess wax and dye W/D from the threads T. Once applied, the wax and dye W/D will solidify on the threads T and bearing face BF to form a lubricant film.

A vacuum or other technique may be used to partially or fully dry the wax and dye W/D coating. This prevents the bearing face BF of the nut from sticking to any surface, such as packing material on which it may be supported after coating.

The foraminous pad 36 and annular shield 44 can be replaced as often as necessary. Also, the space between the annular shield 44 and the foraminous pad 36, which constitutes the thickness of the nut, can be changed by altering the position of the jamb nut 42 which locates the bottom of the annular shield 44 with respect to the nut end being coated. Moreover, the diameter of the annular shield 44 can be changed to accommodate other diameter nuts N. Also, it is to be understood that, if desired, either permanent or adjustable stop members could be provided, for example, on the holding tray 26 or on the tube 24 to restrict the length of movement on the actuating movement of the pumping mechanism 14.

Accordingly, the preferred embodiments of the present invention have been described. With the foregoing description in mind, however, it is understood that this description is made only by way of example, that the invention is not limited to the particular embodiments described herein, and that various rearrangements, modifications, and substitutions may be implemented without departing from the true spirit of the invention as hereinafter claimed.

What is claimed is:

1. A nut having internal threads, a bearing face, a free face, and a plurality of torquing faces, comprising:
a lubricant on said threads and on said bearing face;
said free face and said torquing face being free of lubricant.

2. The invention as defined in claim 1 wherein said lubricant includes a wax compound.

3. The invention as defined in claim 1 wherein said lubricant includes a dye compound.

4. The invention as defined in claim 1 wherein said lubricant is Castrol Safety Film 639.

5. A method of applying a lubricant to an internally threaded nut having a bearing face, a free face, and torquing faces comprising the steps of:
applying a lubricant to the threads of said nut and the bearing face while maintaining said free face and said torquing faces free of lubricant.

6. The invention as defined in claim 1 wherein said lubricant is sprayed onto said threads.

7. The invention as defined in claim 1 wherein said lubricant is applied to said bearing face from a foraminous pad contacting said bearing face.

8. A method of applying a liquid coating to the threads and only one face of an internally threaded nut comprising the steps of:
A) providing a mechanism that has:
1) a container to receive the liquid to be applied;
2) a pumping mechanism having a:
a) a liquid ejecting device connected with said container, and including
1) a foraminous pad disposed to support said one face of a nut having the liquid applied thereon; and
2) an actuatable delivery mechanism communicating with said container to deliver liquid upon actuation only to the threads of the nut and the foraminous pad;
B) placing the nut to be coated on said foraminous pad; and thereafter
C) activating said ejecting device;
whereby when said container has liquid disposed thereon and the ejecting device is actuated, only the threads and said one face of the nut are coated.

9. The invention as defined in claim 8 wherein the coated surfaces of the nut are at least partially dried after step C.

10. A pumping mechanism for applying liquid to the threads and only one face of an internally threaded nut comprising:
a) a container to receive liquid to be applied;
b) a mechanism having:
1) a liquid ejecting device communicating with said container and including:
a) a foraminous pad disposed to support said one face of a nut to which liquid is applied; and
b) an actuatable delivery mechanism disposed in said well to deliver liquid therefrom only to the threads on the foraminous pad of said nut.

11. The invention as defined in claim 19 further characterized by a shield member positioned to prevent dispersed liquid from reaching the face of the nut opposite said one face.

12. The invention as defined in claim 10 wherein said delivery device includes a nozzle with at least one radially directed port.

13. The invention as defined in claim 10 wherein said delivery device includes a reciprocally mounted pumping device.

14. The invention as defined in claim 10 further characterized by a holding tray positioned to receive drainage from said foraminous pad.

15. The invention as defined in claim 14 wherein said holding tray for drainage connects to said container.

16. A method of lubricating a nut having internal threads, a bearing face and a free face, comprising the steps of coating only the bearing face and the threads of the nut with a lubricant while maintaining the free face free of said lubricant.

17. The invention as defined in claim 16 wherein said threads are coated by spraying.

18. The invention as defined in claim 16 wherein said bearing face is coated by contact with a foraminous pad having the coating coated thereon.

19. The method of claim 16 wherein the threads are coated by spraying and the bearing face is coated by contact with a foraminous pad having lubricant soaked thereon.
